(19) United States
(12) Patent Application Publication
(10) Pub. No.: US 2011/0116504 A1
(43) Pub. Date: May 19, 2011

(54) METHOD AND APPARATUS FOR PROVIDING MULTICAST SERVICE IN A MULTICAST NETWORK

(75) Inventor: Heyn-Woo JUNG, Suwon-si (KR)

(73) Assignee: SAMSUNG ELECTRONICS CO. LTD., Suwon-si (KR)

(21) Appl. No.: 12/939,490

(22) Filed: Nov. 4, 2010

(30) Foreign Application Priority Data
Nov. 19, 2009 (KR) 10-2009-0112011

(51) Int. Cl. H04L 12/56

(52) U.S. Cl. 370/390

(57) ABSTRACT

A method and apparatus for efficiently providing a multicast service at a multicast router in a multicast network are provided. A method for providing a multicast service at a multicast server in a multicast network includes transmitting to a first router a multicast signaling packet for establishing a path for transmitting and receiving a multicast service packet to and from a reception side that receives the multicast service, determining whether it is a predefined time to start multicast service packet transmission, and if it is the predefined time to start multicast service packet transmission, transmitting a multicast service packet to the first router.

### PRIORITY

This application claims the benefit under 35 U.S.C. §119(a) of Korean patent application filed in the Korean Intellectual Property Office on Nov. 19, 2009 and assigned Serial No. 10-2009-0112011, the entire disclosure of which is hereby incorporated by reference.

### BACKGROUND OF THE INVENTION

1. Field of the Invention

The present invention relates to a multicast network. More particularly, the present invention relates to a method and apparatus for providing a multicast service to enable a multicast router to efficiently implement the multicast service in a multicast network.

2. Description of the Related Art

Communication systems are under development to provide a variety of services including broadcasting, multimedia video, multimedia messages, etc. In particular, active research is being conducted to provide users with high-speed services with various Quality of Service (QoS) requirements in future-generation communication systems.

These future-generation communication systems provide a variety of services through interaction between a wired network and a wireless network. The future-generation communication systems include a Broadband Wireless Access (BWA) communication system, for example, a Mobile Internet or Worldwide Interoperability of Microwave Access (WiMAX) system based on the Institute of Electrical and Electronics Engineers (IEEE) 802.16 standard.

Among the present future-generation communication systems, a technique for providing users with various services such as broadcasting, multimedia video, multimedia messages, etc. in a multicast or broadcast manner is yet to be specified for WiMAX. Multicast services are classified into a static multicast service and a dynamic multicast service. For the static multicast service and the dynamic multicast service, a multicast router establishes a path in which, for example, a mobile or stationary Mobile Station (MS) can receive a multicast service packet.

Conventionally, to provide a multicast service, a receiver registers a multicast group address and establishes a path in which a multicast service packet is delivered, based on the registered multicast group address. At the time when a multicast router receives the first multicast service packet having the multicast group address from a multicast server, the path is established. When the multicast server starts the multicast service, at least one multicast router in a multicast network transmits a multicast service packet simultaneously while establishing a path for transmission of multicast service packets. If too many interfaces exist among multicast routers in the multicast network or the multicast network is too complex, at least one multicast router transmits a multicast service packet simultaneously while initially establishing a path to a multicast group address to which the multicast service is destined. Therefore, the first multicast router to receive a multicast service packet in the multicast network may undergo performance degradation.

Accordingly, there exists a need for a method and apparatus for providing a multicast service in order to control a multicast router to efficiently implement the multicast service in a multicast network.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for providing a multicast service in order to control a multicast router to efficiently implement the multicast service in a multicast network.

Another aspect of the present invention is to provide a method and apparatus for providing a multicast service in order to reduce performance degradation of a multicast router in a multicast network.

A further aspect of the present invention is to provide a method and apparatus for providing a multicast service in order to control a multicast router to establish a path and transmission of a multicast service packet at different time points in a multicast network.

In accordance with an aspect of the present invention, a method for providing a multicast service at a multicast server in a multicast network is provided. The method includes transmitting to a first router a multicast signaling packet for establishing a path for transmitting and receiving a multicast service packet to and from a reception side that receives the multicast service, and determining whether it is a predefined time to start multicast service packet transmission, and if it is the predefined time to start multicast service packet transmission, transmitting a multicast service packet to the first router.

In accordance with another aspect of the present invention, a method for providing a multicast service at a router in a multicast network is provided. The method includes receiving from a multicast server a multicast signaling packet for establishing a path for transmitting to and from a reception side that receives the multicast service, establishing the path with the reception side according to the received multicast signaling packet, receiving a multicast service packet from the multicast server, after the path is established, and transmitting the received multicast service packet to the reception side via the established path.

In accordance with another aspect of the present invention, a multicast server for providing a multicast service in a multicast network is provided. The server includes a packet generator for generating a multicast signaling packet for establishing a path for transmitting and receives a multicast service packet to and from a reception side that receives the multicast service and for generating a multicast service packet, a transmitter for transmitting the multicast signaling packet and the multicast service packet generated from the packet generator to a first router, and a controller for determining whether it is a predefined time to start multicast service packet transmission after the multicast signaling packet is transmitted, and if it is the predefined time to start multicast service packet transmission, for controlling the transmitter to transmit the multicast service packet to the first router.

In accordance with a further aspect of the present invention, a router for providing a multicast service in a multicast network is provided. The router includes a receiver for receiving from a multicast server a multicast signaling packet for establishing a path for transmitting and receiving a multicast service packet to and from a reception side that receives the multicast service and for receiving a multicast service packet from the multicast server after the path is established, a controller for establishing the path with the reception side according to the received multicast signaling packet, and a transmitter for transmitting the received multicast service packet to the reception side via the established path.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates the configuration of a multicast network according to an exemplary embodiment of the present invention;

FIG. 2 is a block diagram of a multicast server and a router unit in a multicast network according to an exemplary embodiment of the present invention; and

FIG. 3 is a diagram illustrating a packet flow in a multicast network according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention allow for a multicast router to generate and transmit a multicast signaling packet for use in establishing a path before transmitting a multicast service packet so that the establishment of the path and the multicast service packet transmission may take place at different time points at the multicast router in a multicast network. Therefore, the performance degradation of the multicast router can be mitigated in the multicast network.

For this purpose, a method and apparatus for controlling transmission of a multicast service packet and a multicast signaling packet in a multicast network according to an exemplary embodiment of the present invention will be described below. The terms ‘multicast service packet’ and ‘multicast signaling packet’ will be commonly referred to as ‘multicast packet’.

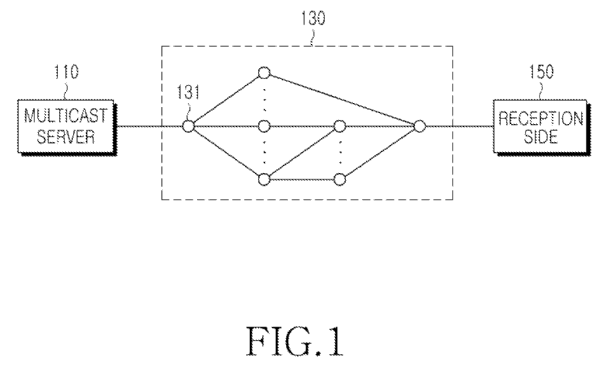

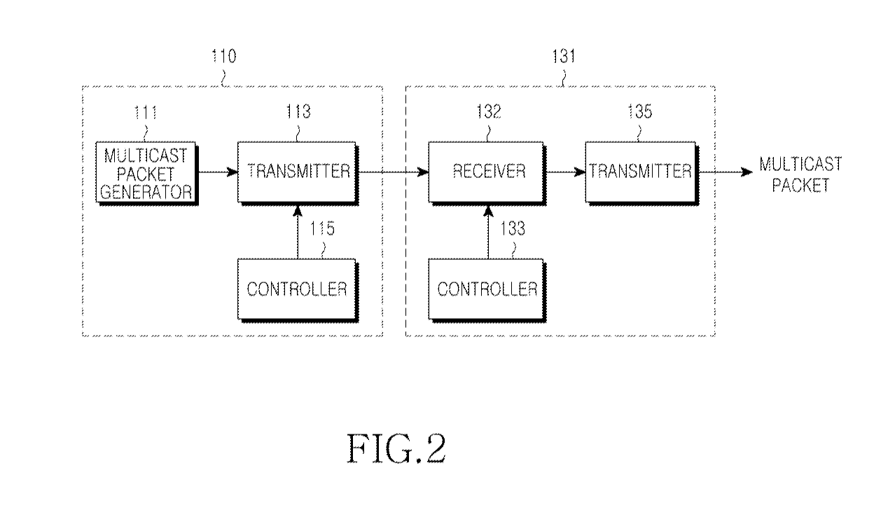

FIG. 1 illustrates the configuration of a multicast network according to an exemplary embodiment of the present invention and FIG. 2 is a block diagram of a multicast server and a router unit in a multicast network.

Referring to FIG. 1, the multicast network includes a multicast server 110 included in a transmission side, a router unit 130 including at least one router, and a reception side 150.

The multicast server 110, which is configured as illustrated in FIG. 2, generates a multicast packet and transmits the multicast packet to a first router 131. The first router 131 is included in the router unit 130. For convenience in description, only an operation of the first router 131 will be described. All routers of the router unit 130 operate in the same manner as the first router 131.

Referring to FIGS. 1 and 2, upon initiation of a multicast service, a multicast packet generator 111 of the multicast server 110 generates a multicast signaling packet and then a multicast service packet. The multicast signaling packet includes a destination address corresponding to a multicast group address of the reception side 150 and a source address corresponding to an Internet Protocol (IP) address of the multicast server 110. The destination address is the address of a destination to which the multimedia service packet is directed. Before transmitting the multicast service packet, a transmitter 113 transmits the multicast signaling packet to the first router 131 under the control of a controller 115. The controller 115 presets a time to start multicast service packet transmission to a minimum time required to receive the multicast signaling packet at the first router 131 and complete the establishment of a path between the first router 131 and the reception side 150. If the preset transmission start time comes after the multicast signaling packet is transmitted, the controller 115 controls the transmitter 113 to transmit the multicast service packet. The multicast server 110 may further include a timer (not shown) to count the time to start the multicast service packet transmission.

The router unit 130 includes at least one router. As illustrated in FIG. 2, the at least one router establishes a path to the reception side 150. FIG. 2 illustrates only the first router 131 that receives a multicast packet first among one or more routers, by way of example. Referring to FIG. 2, a receiver 132 of the first router 131 receives from the multicast server 110 the multicast signaling packet for establishing a path for transmission and reception of a multicast service packet to and from the reception side 150. A controller 133 checks the destination address included in the multicast signaling packet and establishes a path in which a multicast service packet can be delivered to the reception side 150 at the destination address. Upon receipt of a multicast service packet from the multicast server 110, a transmitter 135 of the first router 131 transmits the received multicast service packet to the reception side 150 via the established path.

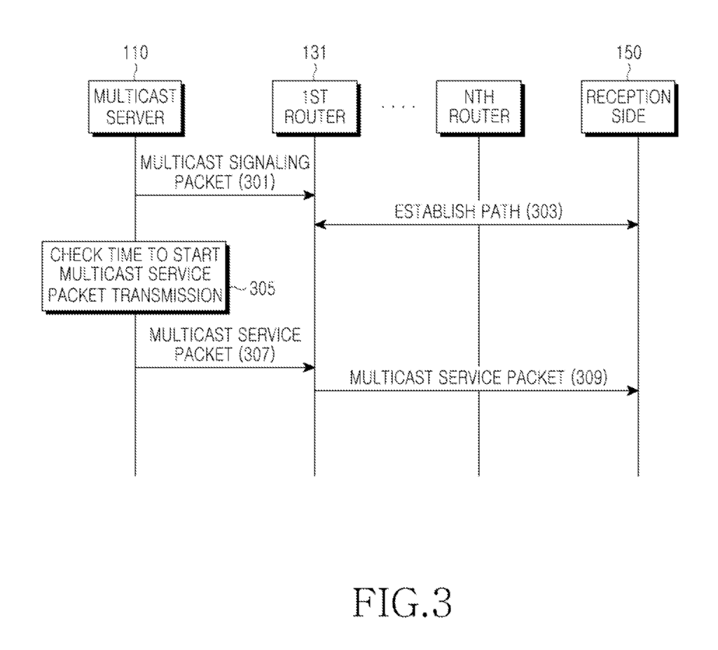

FIG. 3 is a diagram illustrating a packet flow in the multicast network according to an exemplary embodiment of the present invention.

Referring to FIG. 3, the multicast server 110 generates a multicast signaling packet including the multicast group address of the reception side 150 as a destination address and the Internet Protocol (IP) address of the multicast server 110 as a source address and transmits the multicast signaling packet to the first router 131 in step 301.

In step 303, the first router 131 checks the destination address in the received multicast signaling packet and establishes a path to the reception side 150 corresponding to the destination address. If the multicast network includes a plurality of (N) routers, at least one router receives the multicast signaling packet and establishes a path to the reception side 150 in step 303.

The multicast server 110 determines whether it is a predefined time to start transmission of a multicast service in step 305. If it is the predefined time to start transmission of a multicast service packet, the multicast server 110 transmits a multicast service packet to the first router 131 in step 307. The predefined start time of transmitting a multicast service packet is a minimum time required to receive the multicast signaling packet and complete the establishment of the path between the first router 131 and the reception side 150.

In step 309, the first router 131 transmits the received multicast service packet to the reception side 150 via the established path.

Since the first router 131 carries out the establishment of the path and the multicast service packet transmission at different time points in the multicast network, the performance degradation of the first router 131 can be reduced. If the exemplary embodiments of the present invention are applied to a multicast network, the following effects may be achieved.

Multicast protocol modes are generally classified into Dense Mode (DM) and Sparse Mode (SM).

In the DM, a multicast packet is transmitted to all interfaces before a multicast path is established. After the path is established, interfaces to which a multicast packet does not need to be transmitted are set to a non-transmission state. The DM may be used when a large number of multicast receivers perform a multicast service simultaneously.

In the SM, a multicast packet is not transmitted to all interfaces before a multicast path is established. After the path is established, interfaces to which a multicast packet needs to be transmitted are set to a transmission state. The SM may be used when a small number of multicast receivers perform a multicast service simultaneously.

If a small number of multicast servers implement a multicast service in a multicast network operating in the DM, the overhead of changing the state information of paths may be increased at multicast routers. In this case, exemplary embodiments of the present invention can decrease the performance degradation of the routers. In particular, the effects of exemplary embodiments of the present invention may be increased as the interfaces of multicast routers increase in number. The same effects may be achieved when a multicast service is performed in a large number of receivers in the SM.

As is apparent from the above description of the exemplary embodiments of the present invention, a multicast router to first receive a multicast packet performs establishment of the path and multicast service packet transmission at different time points. Therefore, the performance degradation of the multicast router can be reduced in a multicast network.

Exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, Read-Only Memory (ROM), Random-Access Memory (RAM), Compact Disc (CD)-ROMs, magnetic tapes, floppy disks, and optical data storage devices. The computer-readable recording medium can also be distributed over network-coupled computer systems so that the computer-readable code is stored and executed in a distributed fashion. Also, function programs, codes, and code segments for accomplishing the present invention can be easily construed as within the scope of the invention by programmers skilled in the art to which the present invention pertains.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method for providing a multicast service at a multicast server in a multicast network, the method comprising:
transmitting to a first router a multicast signaling packet for establishing a path for transmitting and receiving a multicast service packet to and from a reception side that receives the multicast service; and
determining whether it is a predefined time to start multicast service packet transmission, and if it is the predefined time to start multicast service packet transmission, transmitting a multicast service packet to the first router.

2. The method of claim 1, wherein the predefined time to start multicast service packet transmission is a minimum time required to complete the establishment of the path between the first router and the reception side.

3. The method of claim 2, wherein the first router receives the multicast signaling packet and the multicast service packet earlier than any other router.

4. The method of claim 1, wherein the first router receives the multicast signaling packet and the multicast service packet earlier than any other router.

5. The method of claim 1, wherein the multicast signaling packet includes a destination address corresponding to an address of the reception side and a source address corresponding to an address of the multicast server.

6. The method of claim 1, wherein the determination comprises determining whether it is the predefined time to start multicast service packet transmission, using a timer.

7. The method of claim 1, wherein the multicast network is operating in one of a Dense Mode (DM) and a Sparse Mode (SM).

8. A method for providing a multicast service at a router in a multicast network, the method comprising:
receiving from a multicast server a multicast signaling packet for establishing a path for transmitting and receiving a multicast service packet to and from a reception side that receives the multicast service;
establishing the path with the reception side according to the received multicast signaling packet;
receiving a multicast service packet from the multicast server, after the path is established; and
transmitting the received multicast service packet to the reception side via the established path.

9. The method of claim 8, wherein the multicast signaling packet includes a destination address corresponding to an address of the reception side and a source address corresponding to an address of the multicast server.

10. The method of claim 8, wherein the multicast network is operating in one of a Dense Mode (DM) and a Sparse Mode (SM).

11. A multicast server for providing a multicast service in a multicast network, the server comprising:
a packet generator for generating a multicast signaling packet for establishing a path for transmitting and receiving a multicast service packet to and from a reception side that receives the multicast service and for generating a multicast service packet;
a transmitter for transmitting the multicast signaling packet and the multicast service packet generated from the packet generator to a first router; and
a controller for determining whether it is a predefined time to start multicast service packet transmission after the multicast signaling packet is transmitted, and if it is the predefined time to start multicast service packet transmission, for controlling the transmitter to transmit the multicast service packet to the first router.

12. The server of claim 11, wherein the predefined time to start multicast service packet transmission is a minimum time required to complete establishment of the path between the first router and the reception side.

13. The server of claim 12, wherein the first router receives the multicast signaling packet and the multicast service packet earlier than any other router.

14. The server of claim 11, wherein the first router receives the multicast signaling packet and the multicast service packet earlier than any other router.

15. The server of claim 11, wherein the multicast signaling packet includes a destination address corresponding to an address of the reception side and a source address corresponding to an address of the multicast server.

16. The server of claim 11, further comprising a timer for counting the predefined time to start multicast service packet transmission.

17. The server of claim 11, wherein the multicast network is operating in one of a Dense Mode (DM) and a Sparse Mode (SM).

18. A router for providing a multicast service in a multicast network, the router comprising:
a receiver for receiving from a multicast server a multicast signaling packet for establishing a path for transmitting and receiving a multicast service packet to and from a reception side that receives the multicast service and for receiving a multicast service packet from the multicast server after the path is established;
a controller for establishing the path with the reception side according to the received multicast signaling packet; and
a transmitter for transmitting the received multicast service packet to the reception side via the established path.

19. The router of claim 18, wherein the multicast signaling packet includes a destination address corresponding to an address of the reception side and a source address corresponding to an address of the multicast server.

20. The router of claim 18, wherein the multicast network is operating in one of a Dense Mode (DM) and a Sparse Mode (SM).
